(19) United States
(12) Patent Application Publication
(10) Pub. No.: US 2025/0246985 A1
(43) Pub. Date: Jul. 31, 2025

(54) SWITCHED-MODE POWER SUPPLY (SMPS)

(71) Applicant: STMicroelectronics International N.V., Geneva (CH)

(72) Inventors: Sebastien ORTET, Chateauneuf-le-Rouge (FR); Florian GIRAUDON, Aix-en-Provence (FR)

(73) Assignee: STMicroelectronics International N.V., Geneva (CH)

(21) Appl. No.: 19/028,673

(22) Filed: Jan. 17, 2025

(30) Foreign Application Priority Data
Jan. 29, 2024 (FR) FR2400814

(51) Int. Cl. H02M 1/00; H02M 3/158

(52) U.S. Cl. CPC H02M 1/0032; H02M 3/158

(57) ABSTRACT

A switched-mode power supply includes a first switch coupling a first node receiving a power supply voltage to a second node supplying an output voltage and a second switch coupling a third node receiving a reference voltage to the second node. A comparator functions to compare the output voltage with a comparison voltage. When the switched-mode power supply is operating in a pulse skipping mode, the comparator generates an output signal indicating that the output voltage is higher than the comparison voltage during part of the conduction phase of the first switch. The switched-mode power supply transitions from a pulse skipping mode to the continuous conduction mode as soon as the output voltage is lower than the comparison voltage.

### PRIORITY CLAIM

This application claims the priority benefit of French Application for Patent No. 2400814, filed on Jan. 29, 2024, the content of which is hereby incorporated by reference in its entirety to the maximum extent allowable by law.

### TECHNICAL FIELD

The present disclosure generally concerns electronic systems and, in particular, circuits for powering these systems. The disclosure more particularly concerns switched-mode power supplies and their different operating modes.

### BACKGROUND

There exist several types of power supply circuits enabling to deliver a current/voltage pair to an electronic circuit, device, or system, or more generally to a load. Linear power supplies and switched-mode power supplies are examples of power supply circuits.

A switched-mode power supply (SMPS) is a power supply circuit configured to supply a DC voltage, generally from another DC voltage. Switched-mode power supplies are generally DC/DC converters, but certain switched-mode power supplies may comprise a rectifying stage enabling them to take as an input an AC voltage, for example, the power supply mains.

It would be desirable to be able to at least partly improve certain aspects of known switched-mode power supplies.

There is a need for higher-performance switched-mode power supplies.

There is a need for switched-mode power supplies consuming less energy.

There is a need to overcome all or part of the disadvantages of known switched-mode power supplies.

### SUMMARY

According to a first aspect, an embodiment provides a switched-mode power supply exhibiting less oscillations on its output voltage during a transition from a pulse skipping mode (PSK) to a continuous conduction mode (CCM).

An embodiment provides a switched-mode power supply comprising a comparator, comparing the output voltage of the switched-mode power supply with a reference voltage, having its output forced to one for at least 20% of the conduction time of a switch of the switched-mode power supply outputting a reference voltage (for example, a ground voltage).

An embodiment provides a switched-mode power supply comprising: a first switch coupling a first node configured to receive a first power supply voltage to a second node configured to supply a second output voltage; and a comparator configured to compare said second output voltage with a third comparison voltage; wherein, when the switched-mode power supply is operating in a pulse skipping mode, the comparator is configured to indicate that the second output voltage is higher than the third comparison voltage during part of the conduction phase of said first switch.

Another embodiment provides a method of implementation a switched-mode power supply comprising: a first switch coupling a first node receiving a power supply voltage to a second node supplying a second output voltage; a comparator adapted to comparing said second output voltage with a third comparison voltage; wherein, when the switched-mode power supply is operating in a pulse skipping mode, the comparator is configured to indicate that the second output voltage is higher than the third comparison voltage during part of the conduction phase of said first switch.

According to an embodiment, said part of the conduction phase extends from a first (intermediate) time subsequent to a second initial time of said conduction phase and until a third final time of said conduction phase.

According to an embodiment, said portion has a duration greater than or equal to 20% of the duration of said conduction phase.

According to an embodiment, the first switch is a PMOS-type transistor.

According to an embodiment, said comparator comprises a circuit for adapting its output signal.

According to an embodiment, the circuit for adapting its output signal is an OR logic gate.

According to an embodiment, the switched-mode power supply further comprises a circuit for controlling said first switch adapted to receiving an output from said comparator.

According to an embodiment, said circuit for controlling is a state machine.

According to an embodiment, the switched-mode power supply further comprises a second switch coupling a third node receiving a fourth reference voltage to said second output node.

According to an embodiment, the second switch is an NMOS-type transistor.

According to an embodiment, the switched-mode power supply further comprises a coil coupling the first switch to said second output node.

According to an embodiment, the switched-mode power supply further comprises a zero-current detection circuit configured to detect whether a current flowing through said coil is zero.

According to an embodiment, the switched-mode power supply transitions from a continuous conduction mode (CCM) to a pulse skipping mode (PSK) when said second output voltage is higher than said third comparison voltage, and said current flowing through said coil is zero.

According to an embodiment, the switched-mode power supply transitions from a pulse skipping mode to a DC conduction mode when said second output voltage is lower than said third comparison voltage, and said current flowing through said coil is zero.

According to a second aspect, an embodiment provides a switched-mode power supply consuming less energy during a transition from a pulse skipping mode (PSK) to a continuous conduction mode (CCM).

An embodiment provides a switched-mode power supply comprising a comparator such as described hereabove, and for which a transition from a pulse skipping mode to a continuous conduction mode is performed during a conduction phase of the NMOS transistor of the switched-mode power supply.

An embodiment provides a switched-mode power supply comprising: a first switch coupling a first node receiving a first power supply voltage to a second node supplying a second output voltage; a second switch coupling a third node receiving a fourth reference voltage to said second output node; and a comparator configured to compare said second output voltage with a third comparison voltage, wherein, when the switched-mode power supply is operating in a pulse skipping mode, the comparator is configured to indicate that the second output voltage is higher than the third comparison voltage during part of the conduction phase of said first switch, and wherein the switched-mode power supply transitions from a pulse skipping mode to a continuous conduction mode as soon as said second output voltage is lower than said third comparison voltage.

Another embodiment provides a method of implementation of a switched-mode power supply comprising: a first switch coupling a first node receiving a first power supply voltage to a second node supplying a second output voltage; a second switch coupling a third node receiving a fourth reference voltage to said second output node; and a comparator configured to compare said second output voltage with a third comparison voltage, wherein, when the switched-mode power supply is operating in a pulse skipping mode, the comparator is configured to indicate that the second output voltage is higher than the third comparison voltage during part of the conduction phase of said first switch, and wherein the switched-mode power supply transitions from a pulse skipping mode to a continuous conduction mode as soon as said second output voltage is lower than said third comparison voltage.

According to an embodiment, said part of the conduction phase extends from a first (intermediate) time subsequent to a second initial time of said conduction phase and until a third final time of said conduction phase.

According to an embodiment, said part has a duration greater than or equal to 20% of the duration of said conduction phase.

According to an embodiment, the first switch is a PMOS-type transistor.

According to an embodiment, the second switch is an NMOS-type transistor.

According to an embodiment, the switched-mode power supply further comprises a circuit for controlling said first switch adapted to receiving an output from said comparator.

According to an embodiment, said control circuit is a state machine.

### BRIEF DESCRIPTION OF THE DRAWINGS

The foregoing features and advantages, as well as others, will be described in detail in the rest of the disclosure of specific embodiments given as an illustration and not limitation with reference to the accompanying drawings, in which:

FIG. 1 shows an embodiment of a switched-mode power supply;

FIG. 2 shows an example of application of the embodiment of FIG. 1;

FIG. 3 shows a diagram illustrating a first aspect of the operation of the embodiment of FIG. 1;

FIG. 4 shows timing diagrams illustrating a first implementation mode of the embodiment of FIG. 1;

FIG. 5 shows a practical example of implementation of the first implementation mode of FIG. 4;

FIG. 6 shows timing diagrams illustrating a second implementation mode of the embodiment of FIG. 1;

FIG. 7 shows a practical example of implementation of the second implementation mode of FIG. 6;

FIG. 8 shows a diagram illustrating a second aspect of the operation of the embodiment of FIG. 1; and

FIG. 9 shows graphs illustrating the operation described in relation with FIG. 8.

### DETAILED DESCRIPTION

Like features have been designated by like references in the various figures. In particular, the structural and/or functional features that are common among the various embodiments may have the same references and may dispose identical structural, dimensional and material properties.

For clarity, only those steps and elements which are useful to the understanding of the described embodiments have been shown and are described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, where reference is made to absolute position qualifiers, such as “front”, “back”, “top”, “bottom”, “left”, “right”, etc., or relative position qualifiers, such as “top”, “bottom”, “upper”, “lower”, etc., or orientation qualifiers, such as “horizontal”, “vertical”, etc., reference is made unless otherwise specified to the orientation of the drawings.

Unless specified otherwise, the expressions “about”, “approximately”, “substantially”, and “in the order of” signify plus or minus 10%, preferably of plus or minus 5%.

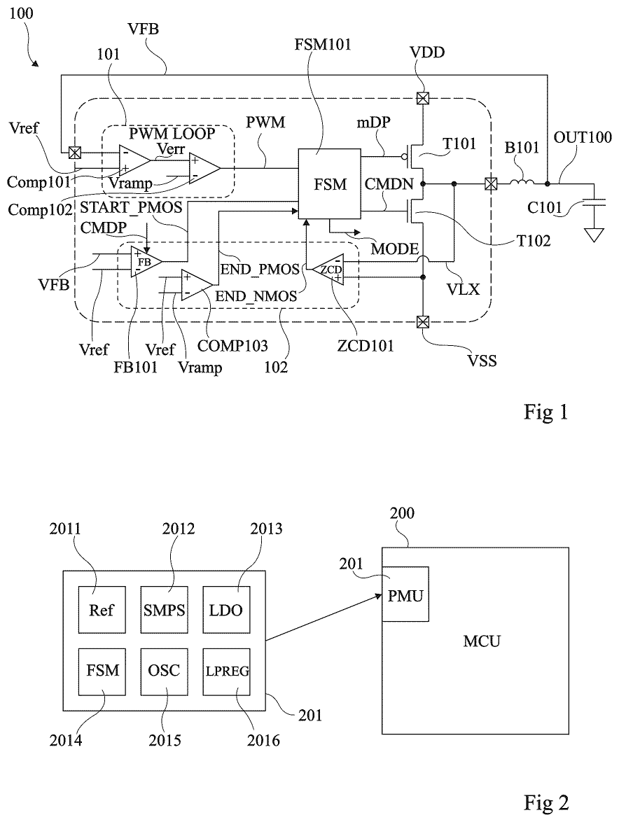

The embodiments described hereafter concern the improvement of known switched-mode power supplies. Switched-mode power supplies are circuits enabling to supply a DC power supply voltage, generally by taking as an input another DC voltage, or an AC voltage. The switched-mode power supplies concerned herein are DC/DC converters, that is, converters of a DC voltage into a DC voltage. FIG. 1 shows a switched-mode power supply according to an embodiment and FIG. 2 details an example of application of such a switched-mode power supply.

Switched-mode power supplies often comprise a plurality of operating modes, depending on the size of the load connected to the output of the switched-mode power supply, called output load hereafter. A first operating mode is the continuous conduction mode (CCM) which is used for high output loads. A second operating mode is the pulse skipping mode (PSK) or pulse frequency modulation mode (PFM) which is used for low output loads.

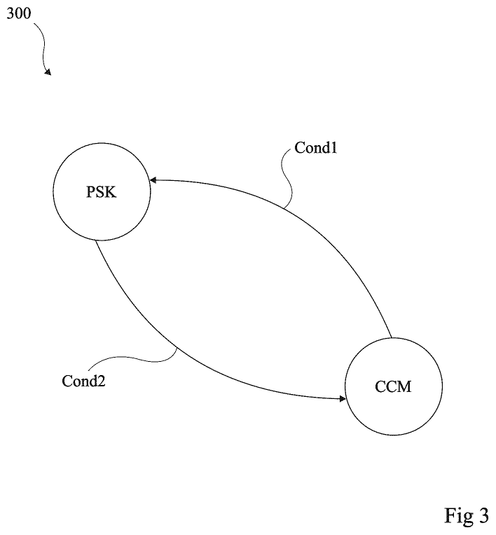

According to a first aspect, the embodiments described hereafter concern the case where a medium output load, that is, a load which is neither high nor low, is connected to the output of the switched-mode power supply. In this configuration, the switched-mode power supply may perform a series of transitions between CCM and PSK modes, and oscillations may appear on the output voltage of the switched-mode power supply. To overcome this problem, the methods described hereafter provide for modifying the comparator which is configured to determine the size of the output load. FIGS. 3 to 7 detail these embodiments.

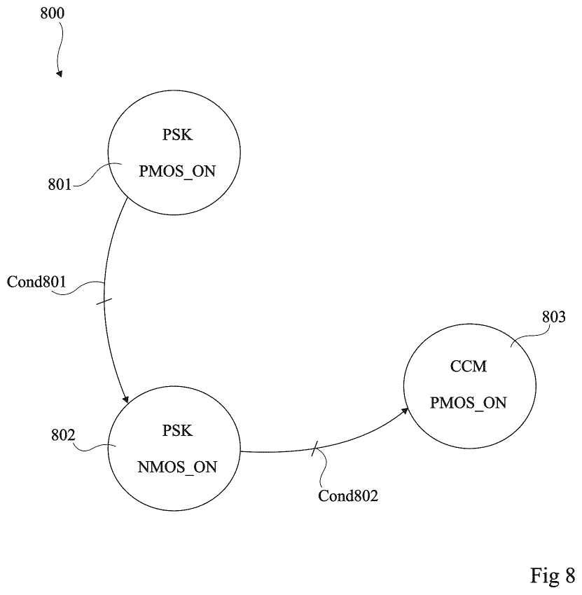

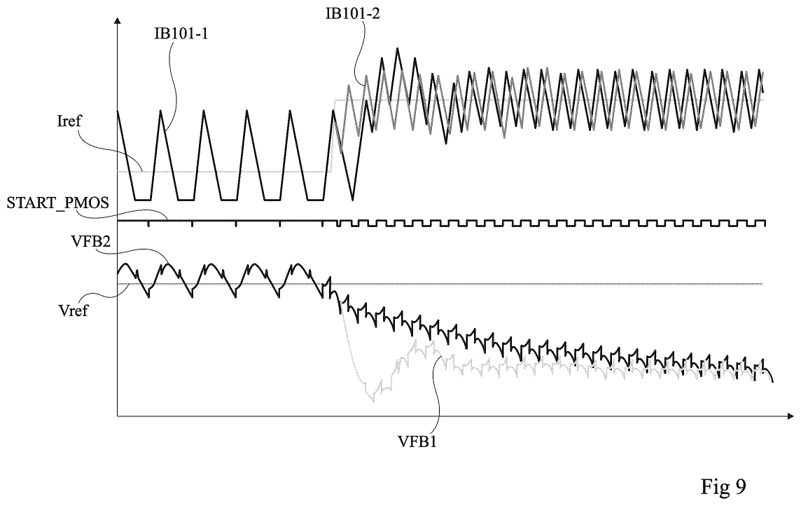

According to a second aspect, the embodiments described hereafter disclose a way of saving energy during a transition from a PSK mode to a CCM mode. FIGS. 8 and 9 show these embodiments in detail.

FIG. 1 is an electric diagram of an embodiment of a switched-mode power supply 100.

Switched-mode power supply 100 comprises two switches T101 and T102 coupled in series between two nodes receiving, for one of them, a DC power supply voltage VDD, and, for the other, a reference voltage VSS, for example a ground voltage. A first conduction terminal of switch T101 is coupled, preferably connected, to the node supplying power supply voltage VDD, and a second conduction terminal of switch T101 is coupled, preferably connected, to a first terminal of switch T102. A second conduction terminal of switch T102 is coupled, preferably connected, to the node supplying reference voltage VSS.

Switches T101 and T102 are, for example, transistors, and, more particularly, metal-oxide-semiconductor field-effect transistors, or MOSFET transistors, or MOS transistors. More specifically, transistor T101 is a P-channel MOS transistor, or P-type MOS transistor, or PMOS transistor, and transistor T102 is an N-channel MOS transistor, or N-type MOS transistor, or NMOS transistor. Other types of switches will readily occur to those skilled in the art and, in particular, other types of transistors, such as bipolar transistors, can be used herein. Further, there are here shown inversely-controlled switches T101 and T102, but it is within the abilities of those skilled in the art to form switched-mode power supply 100 with similarly-controlled switches.

Switched-mode power supply 100 further comprises a control circuit FSM101 (FSM) configured to control switches T101 and T102. According to an example, control circuit FSM101 is an automaton, such as a state machine or a finite-state machine (FSM). The control circuit receives, as an input, a plurality of signals from the other circuits forming switched-mode power supply 100, described hereafter, and delivers, as an output, a control signal CMDP intended to control switch T101, and a control signal CMDN intended to control switch T102. Control circuit FSM101 manages the operating modes of switched-mode power supply 100, that is, the CCM and PSK modes. For this purpose, control circuit FSM101 may further supply a signal MODE indicating the current operating mode of switched-mode power supply 100.

The switched-mode power supply further comprises a coil B101 and an output capacitor C101. Coil B101 is coupled to the junction node of switches T101 and T102 and to an output node OUT100 of switched-mode power supply 100. Thus, a first conduction terminal of coil B101 is coupled, preferably connected, to the junction node of switches T101 and T102, and a second conduction terminal of coil B101 is coupled, preferably connected, to node OUT100. Node OUT100 supplies a feedback voltage VFB which is an image of the output voltage of switched-mode power supply 100. Capacitor C101 may be external to switched-mode power supply 100, and is coupled between output node OUT100 and the ground. Thus, a first conduction terminal of capacitor C101 is coupled, preferably connected, to node OUT100, and a second conduction terminal of capacitor C101 is coupled, preferably connected, to the node receiving reference voltage VSS, or to a node receiving another reference voltage different from reference voltage VSS.

The switched-mode power supply further comprises a pulse-width modulation loop 101 (PWM Loop) comprising an inverter amplifier Comp101 and a comparator Comp102 assembled in cascade. Inverter amplifier Comp101 receives, on a non-inverting input, a comparison voltage Vref, and receives, on an inverting input, a feedback voltage VFB from switched-mode power supply 100. Inverter amplifier Comp101 outputs an error voltage Verr. Inverter amplifier Comp101 amplifies the voltage difference between the voltages that it receives as inputs. Comparator Comp102 receives, on a non-inverting input, error voltage Verr, and receives, on an inverting input, a ramp voltage Vramp. Ramp voltage Vramp is generated by a ramp generator circuit of switched-mode power supply 100, which is not shown herein. Comparator Comp102 outputs a pulse-width modulation voltage PWM which is supplied to control circuit FSM101.

The switched-mode power supply further comprises comparison circuits 102 enabling to determine the operating state of switched-mode power supply 100. Comparison circuits 102 comprise: a zero-current detection circuit ZCD101 (ZCD); a circuit FB101 (FB) for comparing feedback voltage VFB with comparison voltage Vref; and a circuit Comp103 for comparing ramp voltage Vramp with comparison voltage Vref.

Zero current detection circuit ZCD101 (ZCD) is configured to detect whether the current flowing through coil B101 changes sign. Circuit ZCD101 is a comparator. For this purpose, circuit ZCD101 receives, on a non-inverting input, reference voltage VSS, and receives, on an inverting input, a voltage VLX supplied by the junction node of switches T101 and T102. Circuit ZCD101 outputs a signal END_NMOS indicating the end of a conduction phase of switch T102.

Circuit FB101 (FB) compares feedback voltage VFB and is configured to estimate the size of the output load of switched-mode power supply 100. For this purpose, circuit FB101 receives, on a non-inverting input, feedback voltage VFB and receives, on an inverting input, comparison voltage Vref. Circuit FB101 outputs a signal START_PMOS indicating the beginning of a conduction phase of switch T101.

Circuit Comp103 compares ramp voltage Vramp and receives, on a non-inverting input, comparison voltage Vref and receives, on an inverting input, ramp voltage Vramp. Circuit Comp103 outputs a signal END_PMOS indicating the end of a conduction phase of switch T102. Circuit Comp103 defines the duration of a conduction phase of switch T101.

The operation of the switched-mode power supply is described in further detail in relation with the embodiments described in relation with FIGS. 3 to 9.

FIG. 2 shows, very schematically and in the form of blocks, an example of the application of a switched-mode power supply of the type of the switched-mode power supply 100 described in relation with FIG. 1.

FIG. 2 more particularly illustrates a microcontroller 200 (MCU) and its power supply unit 201 (PMU). According to an example, power supply unit 201 comprises: a reference signal generation circuit 2011 (Ref); a switched-mode power supply 2012 (SMPS) of the type of the switched-mode power supply 100 of FIG. 1; one or a plurality of voltage converter circuits 2013 (LDO); one or a plurality of state machines 2014 (FSM); one or a plurality of oscillating circuits 2015 (OSC); and one or a plurality of regulation circuits 2016 (LPREG), for example low-power regulation circuits.

Other applications of switched-mode power supply 100 are the following. Such a switched-mode power supply can be used to supply energy to any more or less complex electronic circuit or device.

FIG. 3 is a state diagram 300 illustrating the operation of the switched-mode power supply 100 described in relation with FIG. 1 according to a first aspect.

As previously described, switched-mode power supply 100 comprises a plurality of operating modes depending on the size of its output load. More particularly, switched-mode power supply 100 comprises two operating modes: a continuous conduction mode (CCM), which is used for high output loads, and a pulse skipping mode (PSK), which is used for low output loads.

When switched-mode power supply 100 is in PSK mode, it charges its coil B101 by using voltage peaks separated from one another by a duration depending on the voltage requested by the output load. The lower the load, the longer the duration between peaks.

When switched-mode power supply 100 is in CCM mode, it continuously charges its coil B101 by sending an oscillating voltage to coil B101.

Whether in PSK mode or in CCM mode, the voltage supplying coil B101 is obtained by controlling switches T101 and T102.

To switch from one mode to another, it is necessary to estimate the size of the output load. For this purpose, the output voltage supplied to the output load, having feedback voltage VFB as an image, is compared with comparison voltage Vref. The result of this comparison indicates the operating mode in which the switched-mode power supply should be.

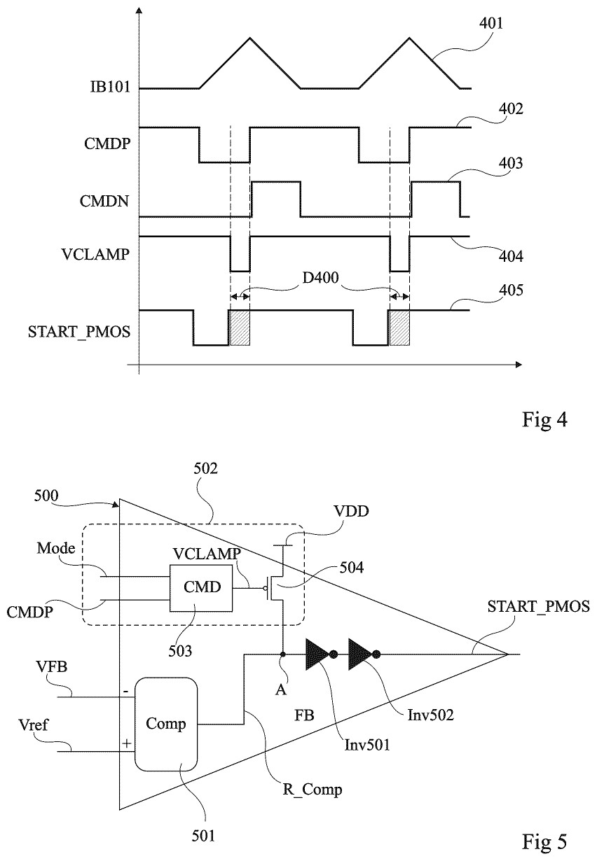

More specifically, when feedback voltage VFB is lower than comparison voltage Vref, switched-mode power supply 100 is supposed to operate in CCM mode, and when feedback voltage VFB is higher than comparison voltage Vref, switched-mode power supply 100 is supposed to operate in PSK mode. This comparison is implemented by the comparator FB101 described in relation with FIG. 1, and is described in further detail in relation with FIGS. 4 to 6.

However, to effectively initiate a transition between one mode and another, and to avoid incessant changes when the load varies around a mean value, it is necessary to take a second criterion into account. Thus, to switch from one state to another, the result of the comparison of feedback voltage VFB with comparison voltage Vref at the time when the current IB101 flowing through coil B101 becomes zero must be taken into account. Current IB101 is thus monitored by the zero-current detection circuit ZCD101 described in relation with FIG. 1.

Thus, to switch from the CCM mode to the PSK mode, it is necessary to meet two conditions (referred to as Cond1): having a feedback voltage VFB greater than comparison voltage Vref, and having the current IB101 flowing through coil B101 which becomes zero.

To switch from the PSK mode to the CCM mode, it is necessary to meet two conditions (referred to as Cond2): having a feedback voltage VFB lower than comparison voltage Vref, and having the current IB101 flowing through coil B101 which becomes zero.

As previously described, to monitor the effectiveness of these conditions, comparator FB101 and detection circuit ZCD101 are implemented. However, according to an embodiment, to compensate for a possible delay of comparator FB101, the result of comparator FB101 is not taken into account during the entire conduction phase of switch T101. This is explained in further detail in relation with FIGS. 4 to 7.

FIG. 4 shows timing diagrams illustrating a first implementation mode of the switched-mode power supply of FIG. 1 in a PSK mode.

FIG. 4 comprises the following timing diagrams: a timing diagram 401 illustrating a theoretical time variation of the current IB101 flowing through coil B101; a timing diagram 402 illustrating the time variation of signal CMDP for controlling switch T101; a timing diagram 403 illustrating the time variation of control signal CMDN for switch T102; a timing diagram 404 illustrating the time variation of a voltage VCLAMP internal to the comparator FB101 described in relation with FIG. 1; and a timing diagram 405 illustrating the time variation of the output signal START_PMOS of the comparator FB101 described in relation with FIG. 1.

As previously described, in a PSK mode, the current IB101 flowing through coil B101 periodically exhibits pulses separated by a duration depending on the value of feedback voltage VFB. More specifically, coil B101 is charged when switch T101 is on, that is, during a conduction phase of switch T101, and is discharged when switch T102 is on, that is, during a conduction phase of switch T102.

A conduction phase of switch T101 is implemented as follows. As soon as feedback voltage VFB becomes lower than comparison voltage Vref, signal START_PMOS exhibits a falling edge, which causes a falling edge of control signal CMDP, and switch T101 turns on. The conduction phase of switch T101 then ends when voltage Vramp (not shown in FIG. 4) becomes higher than comparison voltage Vref, which causes a state change of signal END_PMOS, that is, a rising or falling edge. The state change of signal END_PMOS causes a rising edge of control signal CMDP, which indicates the end of the conduction phase of switch T101.

A conduction phase of switch T102 is implemented as follows. The conduction phase of switch T102 starts when the conduction phase of switch T101 ends, that is, when ramp voltage Vramp becomes greater than comparison voltage Vref. The conduction phase of switch T102 ends when the current IB101 through coil B101 becomes zero, causing a state change of signal END_NMOS (not shown in FIG. 4), which in turn causes a falling edge of control signal CMDN.

As previously mentioned, the transition from the PSK mode to the CCM mode requires the implementation of comparator FB101 and of detection circuit ZCD101. It has been observed by the inventors during test phases that comparator FB101 can exhibit delays which themselves cause delays in the transitions from the PSK mode to the CCM mode. To overcome this problem, the inventors have decided not to take into account the result of comparator FB101 for the entire duration of the conduction phase of switch T101. More particularly, the operation of comparator FB101 is modified to be, further, controlled by voltage VCLAMP, which defines a duration D400 during which the output of comparator FB101 indicates that feedback voltage VFB is higher than comparison voltage Vref whatever the value of feedback voltage VFB. In other words, the operation of comparator FB101 is modified so that, during part of the conduction phase of switch T101, the output of comparator FB101 indicates that feedback voltage VFB is higher than comparison voltage Vref whatever the value of feedback voltage VFB. Such a modified comparator FB101 is described in further detail in relation with FIG. 5.

According to a first embodiment, duration D400 is defined as being in the range from 20% to 100% of the duration of the conduction phase of switch T101. Further, this duration D400 is placed at the end of the conduction phase of switch T101, that is, starts after the beginning of the conduction phase of switch T101 and extends until the end of the conduction phase of switch T101. In other words, the part of the conduction phase extends from a first (intermediate) time subsequent to a second initial time of said conduction phase and until a third final time of said conduction phase.

FIG. 5 shows an example of embodiment of a comparator 500 configured for use as a comparator FB101 in the switched-mode power supply 100 described in relation with FIG. 1.

Comparator 500 comprises a comparison stage 501 (Comp) configured to take as inputs voltage VFB and Vref. More specifically, stage 501 receives, on a non-inverting input, comparison voltage Vref and, on an inverting input, feedback voltage VFB. Stage 501 outputs a result signal R_Comp. This stage 501 is not described in detail herein, since it is within the abilities of those skilled in the art.

Comparator 500 further comprises a circuit 502 configured to adapt the output signal START_PMOS of comparator 500. Circuit 502 receives power supply voltage VDD and signals Mode and CMDP. Circuit 502 comprises a control circuit 503 (CMD) configured to generate voltage VCLAMP, which enables to define duration D400, and a switch 504. Switch 504 receives, on a first conduction terminal, power supply voltage VDD, and has a second conduction terminal coupled, preferably connected, to the output of comparison stage 501. Switch 504 receives, on its control terminal, voltage VCLAMP.

Comparator 500 further comprises, according to an example, two inverter circuits Inv501 and Inv502. An input of inverter circuit Inv501 is coupled, preferably connected, to node A, and an output of inverter circuit Inv501 is coupled, preferably connected, to the input of inverter circuit Inv502. An output of inverter circuit Inv502 supplies the output signal START_PMOS of comparator 500.

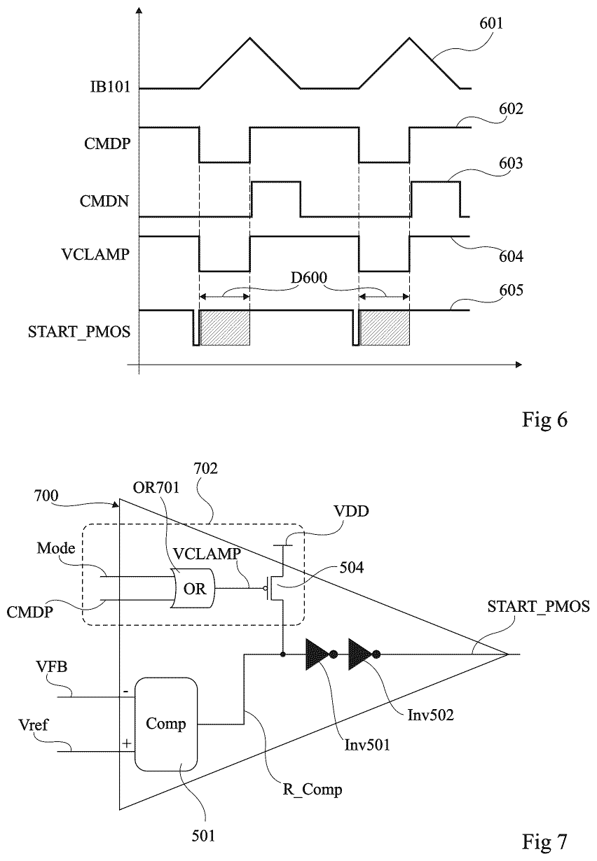

FIG. 6 shows timing diagrams illustrating a second preferred implementation mode of the switched-mode power supply of FIG. 1 in a PSK mode.

FIG. 6 shows the following timing diagrams: a timing diagram 601 illustrating a theoretical time variation of the current IB101 flowing through coil B101; a timing diagram 602 illustrating the time variation of the signal CMDP for controlling switch T101; a timing diagram 603 illustrating the time variation of the signal CMDN for controlling switch T102; a timing diagram 604 illustrating the time variation of a voltage VCLAMP internal to the comparator FB101 described in relation with FIG. 1; and a timing diagram 605 illustrating the time variation of the output signal START_PMOS of the comparator FB101 described in relation with FIG. 1.

This second implementation mode is similar to the first implementation mode described in relation with FIG. 4. The elements common to these two implementation modes are not described again in detail. Only the differences between these implementation modes are highlighted.

As previously mentioned, to avoid delay problems in comparator FB101, voltage VCLAMP is used to modify its operation and introduce a duration D600 during the conduction phase of switch T101. Duration D600 is longer than the duration D400 described in relation with FIG. 4. Duration D600 is equal to maximum duration D400, that is, equal to the duration of a conduction phase of switch T101 to which the time of a pulse enabling to start said conduction phase has been subtracted. A comparator FB101 modified to obtain duration D600 is described in further detail in relation with FIG. 7.

FIG. 7 shows an example of embodiment of a comparator 700 configured for use as a comparator FB101 in the switched-mode power supply 100 described in relation with FIG. 1.

Comparator 700 is similar to the comparator 500 described in relation with FIG. 5. The elements common to comparators 500 and 700 are not described again in detail. Only the differences between comparators 500 and 700 are highlighted.

Comparator 700 comprises: comparison stage 501 (Comp); a circuit 702 for adapting output signal START_PMOS; and inverter circuits Inv501 and Inv502.

Circuit 702 receives power supply voltage VDD and signals Mode and CMDP. Circuit 702 comprises an OR-type logic gate OR701, replacing control circuit 503 (CMD), and a switch 504. A first input terminal of gate OR701 receives signal Mode, and a second input terminal of gate OR701 receives control signal CMDP. An output terminal of logic gate OR701 supplies voltage VCLAMP. Switch 504 receives, on a first conduction terminal, power supply voltage VDD, and has a second conduction terminal coupled, preferably connected, to the output of comparison stage 501. Switch 504 receives, on its control terminal, voltage VCLAMP.

FIG. 8 is a state diagram 800 illustrating the operation of the switched-mode power supply 100 described in relation with FIG. 1 according to a second aspect.

As previously described, switched-mode power supply 100 comprises two operating modes, the CCM mode and the PSK mode. The state diagram 800 of FIG. 8 concerns the transition from the PSK mode to the CCM mode.

After having implemented the switched-mode power supply 100 of FIG. 1 by using one or the other of the comparator circuits 500 or 700 of FIG. 5 or 7, the inventors have found a new way of achieving an energy-saving transition between the PSK mode and the CCM mode.

The implementation mode of a transition between the PSK mode and the CCM mode described below provides only carrying out such a transition during a conduction phase of switch T102. This is possible due to the use of comparators 500 or 700.

When switched-mode power supply 100 operates according to this implementation mode, the switched-mode power supply switches from the PSK mode to the CCM mode only during a conduction phase of switch T102 and when feedback voltage VFB becomes lower than comparison voltage Vref. The zero crossing of the current flowing through coil B101 is no longer taken into account. Indeed, when the implementation modes of FIGS. 4 to 6 are used, the output of comparator FB101 cannot be taken into account during a conduction phase of switch T101, since the latter is modified. Verifying the state of current IB101 only had the function of avoiding erroneously detecting a transition during a conduction phase of switch T101. In particular, the output of circuit ZCD101 was only used during a conduction phase of switch T102, to avoid a false detection due to the slowness of circuit FB101, which compelled to wait for the coil to be emptied of its current.

Otherwise, a transition phase from the PSK mode to the CCM mode comprising the following succession of states: a state 801 (PSK PMOS_ON) where switched-mode power supply 100 is in a PSK mode and during a conduction phase of switch T101; a state 802 (PSK NMOS_ON), where switched-mode power supply 100 is in a PSK mode and during a conduction phase of switch T102; a state 803 (CCM PMOS_ON) where switched-mode power supply 100 enters a CCM mode by a conduction phase of switch T101.

A transition between state 801 and state 802 is performed in the way described in relation with FIG. 4, noted condition Cond801, that is, by using the comparison of voltage Vramp and of comparison voltage Vref.

A transition between state 802 and state 803 is performed by monitoring a single condition Cond802, the result of the comparison of feedback voltage VFB and of comparison voltage Vref.

An advantage of this embodiment is that it also enables to rapidly transition from a PSK mode to a CCM mode when feedback voltage VFB abruptly drops. Indeed, since only this parameter is taken into account, it is taken into account with no delay.

FIG. 9 comprises curves illustrating an advantage of the implementation described in relation with FIG. 8.

FIG. 9 shows the following curves: a curve Iref showing the average value to be reached of the current IB101 flowing through coil B101; a curve IB101-1 showing the variation of the current IB101 flowing through coil B101 without the implementation of the implementation mode of FIG. 8; a curve IB101-2 showing the variation of the current IB101 flowing through coil B101 with the implementation of the implementation mode of FIG. 8; a curve START_PMOS showing the variation of the current IB101 flowing through coil B101 with the implementation of the implementation mode of FIG. 8; a curve START_PMOS representing the variation of signal START_PMOS; a curve VFB1 showing the variation of feedback voltage VFB without the implementation of the implementation mode of FIG. 8; and a curve VFB2 showing the variation of feedback voltage VFB with the implementation of the implementation mode of FIG. 8.

The curves of FIG. 9 more particularly illustrate a transition from the PSK mode to the CCM mode, and compare the implementation mode of FIG. 8 with the operation described in relation with FIG. 3. Thus, two switched-mode power supplies 901 and 902 are here considered, power supply 901 operating in the mode described in relation with FIG. 3, and power supply 902 using the implementation mode of FIG. 8. More specifically, switched-mode power supplies 901 and 902 operate in a PSK mode in a left-hand portion of FIG. 9, and operate in a CCM mode in a right-hand portion of FIG. 9. The transition takes place in a central portion of FIG. 9.

It can be noted that using the implementation mode of FIG. 8 enables to change mode before the coil B101 of power supply 902 is fully discharged. This thus enables to change mode without needing to recharge the coil, which is usually implemented by a boost circuit. The implementation mode of FIG. 8 thus enables to accelerate a transition from a PSK mode to a CCM mode while saving energy.

Various embodiments and variants have been described. Those skilled in the art will understand that certain features of these various embodiments and variants may be combined, and other variants will occur to those skilled in the art.

Finally, the practical implementation of the described embodiments and variants is within the abilities of those skilled in the art based on the functional indications given hereabove.

1. A switched-mode power supply, comprising:
a first switch coupling a first node configured to receive a power supply voltage to a second node supplying an output voltage;
a second switch coupling a third node configured to receive a reference voltage to said second node; and
a comparator configured to compare said output voltage with a comparison voltage;
wherein, when the switched-mode power supply is operating in a pulse skipping mode, the comparator is configured to indicate that the output voltage is higher than the comparison voltage for part of a conduction phase of said first switch; and
a control circuit configured to transition the switched-mode power supply from the pulse skipping mode to a continuous conduction mode in response to said comparator indicating that the output voltage is lower than said comparison voltage.

2. The power supply according to claim 1, wherein said part of the conduction phase extends from a first time which is subsequent to a second time, wherein the second time is an initial time of said conduction phase, and until a third time, wherein the third time is a final time of said conduction phase.

3. The power supply according to claim 1, wherein said part of the conduction phase has a duration greater than or equal to 20% of a duration of said conduction phase from the initial time to the final time.

4. The power supply according to claim 1, wherein the first switch is a PMOS-type transistor.

5. The power supply according to claim 1, wherein the second switch is an NMOS-type transistor.

6. The power supply according to claim 1, wherein the control circuit receives an output from said comparator and is configured to control said first switch.

7. The power supply according to claim 6, wherein said control circuit is a state machine.

8. A switched-mode power supply, comprising:
a first switch coupling a first node receiving a power supply voltage to a second node supplying an output voltage;
a second switch coupling a third node receiving a first reference voltage to said second node; and
a comparator configured to compare a feedback voltage derived from said output voltage with a second reference voltage and generate a control signal that transitions to a first logic state indicating a beginning of a conduction phase of the first switch;
wherein said comparator circuit further includes a clamp circuit configured to clamp the control signal in a second logic state, opposite the first logic state, in response to a combination of a current operating mode of the switched-mode power supply and a switch control signal for controlling the first switch.

9. The power supply according to claim 8, wherein the clamp circuit comprises:
a transistor coupled to the power supply voltage; and
a logic circuit configured to logically combine a mode signal indicating the current operating mode of the switched-mode power supply and the switch control signal;
wherein an output of the logic circuit controls switching of said transistor.

10. The power supply according to claim 9, wherein logic circuit is a logic-OR gate.

11. The power supply according to claim 8, wherein the clamp circuit is configured to clamp the control signal in the second logic state in response to a change in logic state of a mode signal indicating the current operating mode of the switched-mode power supply when the switch control signal is controlling the first switch to be closed.
